(19) United States
(12) Patent Application Publication
(10) Pub. No.: US 2011/0304872 A1
(43) Pub. Date: Dec. 15, 2011

(54) IMAGE FORMING APPARATUS AND NETWORK SYSTEM

(75) Inventor: Hiroshi Odagiri, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/154,566

(22) Filed: Jun. 7, 2011

Related U.S. Application Data
(60) Provisional application No. 61/352,954, filed on Jun. 9, 2010.

(51) Int. Cl. G06K 15/02

(52) U.S. Cl. 358/1.13

(57) ABSTRACT

According to one embodiment, an image forming apparatus including a storage section which holds a job instructed by a user and data to be used for the job, a display section which displays that the job is present based on an association between the job held in the storage section and the user who instructed the job, and a control section which permits the display section to display that the job associated with the user who instructed the job is present based on the association with the user who instructed the job held in the storage section.

### CROSS-REFERENCE TO RELATED APPLICATIONS

This application is based upon and claims the benefit of priority from: U.S. Provisional Application No. 61/352,954 filed on Jun. 9, 2010, the entire contents of each of which are incorporated herein reference.

### FIELD

Embodiments described herein relate generally to an image forming apparatus and to control a job with personal security.

### BACKGROUND

To instruct printout of an image from an arbitrary PC (Personal Computer) or a user (client) with respect to an arbitrary MFP (an image forming apparatus called a Multi-Functional peripheral) positioned on the network, in possible.

Today, in an MFP (on the network), if a user (client) who instructed a job such as printout or the like is authenticated, it is possible to set operation restrictions (manipulation authority) such that only functions available for the authorized user (client) are activated. Since the physical distance to the user (PC) is taken into consideration, in addition.

### BRIEF DESCRIPTION OF THE DRAWINGS

FIG. 1 is an exemplary diagram showing an example of a network system with an MFP according to an embodiment;

FIG. 2 is an exemplary diagram showing an example of display (image) in a display of a user interface unit of the MFP according to an embodiment;

FIG. 3 is an exemplary diagram showing an example of a flowchart of controlling a job with personal security with the MFP according to an embodiment;

FIG. 4 is an exemplary diagram showing an example of display (image) in a display of a user interface unit of the MFP according to an embodiment;

FIG. 5 is an exemplary diagram showing an example of a flowchart of controlling a job with personal security with the MFP according to an embodiment; and

FIG. 6 is an exemplary diagram showing an example of display (image) in a display of a user interface unit of the MFP according to an embodiment.

### DETAILED DESCRIPTION

In general, according to an embodiment, an image forming apparatus comprising: a storage section which holds a job instructed by a user and data to be used for the job; a display section which displays that the job is present based on an association between the job held in the storage section and the user who instructed the job; and a control section which permits the display section to display that the job associated with the user who instructed the job is present based on the association with the user who instructed the job held in the storage section.

Embodiments will now be described hereinafter in detail with reference to the accompanying drawings.

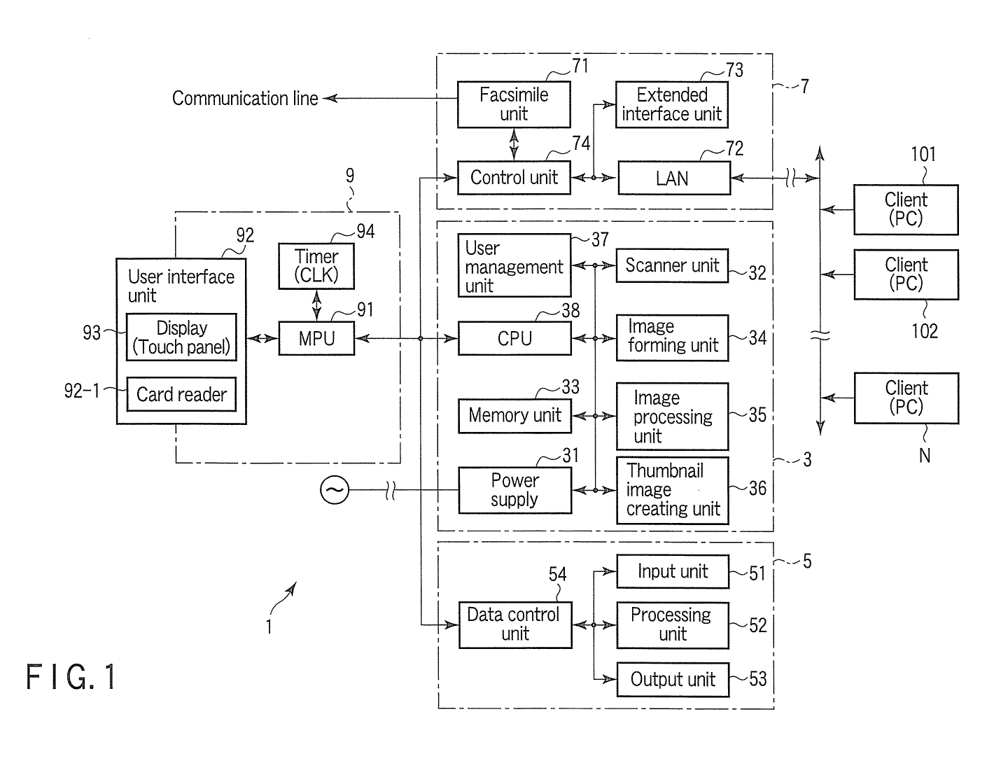

FIG. 1 shows an example of an outline of an MFP (Multi-Functional Peripheral, an electronic apparatus).

An MFP 1 includes at least an image forming section 3, a data managing section 5, a communication control section 7, and a system control section 9. The image forming section 3 visualizes an image or a character on the basis of data of an arbitrary format and outputs the image or the character onto a sheet medium. The data managing section 5 receives data and manages the data for execution of a job such as print output or storage. The communication control section 7 manages transmission and reception of the data to and from a communication line (a network). The system control section 9 controls the operation of the image forming section 3, the data managing section 5, and the communication control section 7, i.e., the MFP 1.

The MFP 1 is connected to an arbitrary number of users (clients) 101, 102, . . . , and N via a network 11. The users (clients) 101, 102, . . . , and N are, for example, personal computers (PC), tablet PCs, or smart phones (high-function portable terminals also called PDA (Personal Digital Assistant)). The users (clients) 101, 102, . . . , and N handle image data, any one of photographic data and text data or both, and the like.

The image forming section 3 includes at least a power supply unit 31, a scanner unit 32, a memory unit 33, an image forming unit 34, an image processing unit 35, a thumbnail image creating unit 36, user management unit 37 and a process control unit (a process controller, CPU) 38 configured to control the each of units of the image forming section 3.

The power supply unit 31 is connected to a commercial power supply and generates a secondary voltage used for the operation of the MFP 1 (from a primary voltage).

If a format of information such as an image, a character, a shape, or a color visualized and output onto a sheet medium by the image forming unit 34 is a non-data format, the scanner unit 32 outputs the information as image data. The scanner unit 32 irradiates light on a sheet-like original document or a three-dimensional object including information, acquires an electric signal corresponding to the intensity of the light reflected on the information (image light), and converts the electric signal into image data.

The memory unit 33 stores the image data obtained by the scanner unit 32 or image data input from the outside. The memory unit 33 also stores a computer program, an application (software), an icon (OSD (on screen display) image) to display a job is present) explained later, or the like.

The image forming unit 34 visualizes the image data and outputs the image data onto a sheet medium. As a method for visualization, an electrostatic transfer system for visualizing, the image data using a toner and a direct recording system for visualizing the image data using ink are often used. A hot stamp or the like for output of special colors (gold and silver) may be used together with the method.

The image forming section 3 stores an image output by the image forming unit 34. The image forming section 3 includes a feeding mechanism for the sheet medium fed to the image forming unit 34.

The image processing unit 35 converts image data read by the scanner unit 32 and held in the memory unit 33, the output data from the PC (client), facsimile reception data, or the like into data for image output required in image formation by the image forming unit 34. The data conversion by the image processing unit 35 includes processing required at the time of image output such as color conversion (RGB-CMY), font replacement if the same font as that designated by the input data is not present, equalization of the thicknesses of lines and underlines (thickening processing in accordance with the reproducibility at the time of print output), for example.

The thumbnail image creating unit 36 creates a preview image (a thumbnail image), which is magnified at a predetermined magnification, for displaying, on the display 93 of the system control section 9, at least image data for one page of the image data read by the scanner unit 32, the output data from the PC (client), or the facsimile reception data.

The user management unit 37 holds an ID list for user authentication held by a built-in memory or the memory unit 33, an identification code used for specifying a user, and an access right thereof and permits the user authorized by a card reader 92-1, for example, to perform print output, access print data from the PC, which is held in the memory 33 (MFP 1) (editing of data to be printed), view and transfer image information obtained by the scanner unit 32, or output a received facsimile document (image output). As the authentication, it is possible to use at least one or combination of face authentication in which characteristics of the user's face are recognized, a biometric authentication unit which recognizes biological characteristics of a user's palm or finger, and the like, for example, as well as the card reader 92-1. In addition, the “user authentication” is used for authentication processing by an ID card (non-contact card) for the MFP 1 under user management or by a user name and a password or the like and for obtaining authority information for the functions of the MFP 1 individually available for a user who inputs a user name and a password (who is authorized by the ID card). The authority information for the functions of the MFP 1 individually available for a user name and a password or a user can be rewritten (updated) by an administrator and managed, if necessary, or at arbitrary timing, as an ID list held in the built-in memory or the memory unit 33 of the user management unit 37 for user authentication, an identification code for specifying a user, and an access right thereof.

The data management section 5 includes at least a data input section 51 which receives input data, a data processing section 52 which performs processing on the data received by the data input unit 51 in order to execute a job independent from the processing allocated to the image processing unit 34 of the image forming section 3 such as development (expansion) for print output, compression for storage in order to be transferred or the like, a data output section 53 which outputs data processed by the data processing section 52 in the form specified by a job, and a data control unit (data controller) 54 which controls data delivery between the data input section 51, the data processing section 52, and the data output section 53.

The communication control section 7 includes at least a facsimile (communication) unit 71 connected to a public communication line and configured to receive or transmit facsimile data, a LAN (communication) unit 72 connected to an external network such as a LAN (Local Area Network) and configured to receive or transmit data from or to a network, an extended interface unit 73 conforming to, for example, a USB (Universal Serial Bus) standard and configured to receive or transmit data from or to a partner connected to the extended interface unit 73, and a communication control unit (a communication controller) 74 configured to control communication with the partner, input, output, and parallel processing for data, and the like by each of the facsimile (communication) unit 71, the LAN (communication) unit 72, and the extended interface unit 73.

The system control section 9 includes at least a main control block (an MPU) 91 and a user interface unit 92 (to which the display (a display unit) 93 integrally including a touch panel (an operation panel) is connected). The user interface unit 92 includes a card reader 92-1, also. The MPU 91 is interconnected to a process controller 37, the data controller 54, and a communication controller 74 of the sections/units explained above and controls the sections/units.

The MPU 91 is connected to a user interface section 92 and outputs, while receiving an instruction input for start or stop of the operation of the sections, condition setting, or the like from an input panel area included in the user interface section 92, a control signal for controlling the operation of the sections according to the instruction input. If, identification information (the medium for authentication) is an ID card, a reading section is prepared in, for example, an armor housing of the scanner unit 32. The medium for authentication (personal authentication) may be a radio ID card. When the medium for authentication is the radio ID card, an antenna and an authentication processing circuit that can input an input signal, i.e., an authentication result to the user interface section 92 are prepared in the armor housing of the scanner unit 32.

The touch panel (the display) 93 detects an instruction (control) input by a touch of a finger of the user and inputs (instructs), for example, start of copying or scanning, display of scan data or facsimile data, start of the image combination or the like to the MPU 91.

The MPU 91 is connected to a timer unit 94. The timer unit 94 stores year (yyyy), month (mm), day (DD), hour (HH), and minute (MM) with reference to a clock generated by a clock generating unit (CLK) incorporated in the timer unit 94. For operation of the MPU 91, the clock generating unit (CLK) may be provided in the system control section 9. For counting of time or storage of time data by the timer unit 94, for example, the frequency of the commercial power supply input to the power supply unit 31 of the image forming section 3 may be used or time data (a time-information service signal) included in a broadcast signal (of a space wave) may be directly received.

The arbitrary users (clients) 101, 102, . . . , and N can instruct the MFP 1 to perform print out (output of visualized image data, any one of photographic data and text data or both, or the like to a sheet medium) and facsimile transmission. The users can capture facsimile data received by the MFP 1 or image data, photographic data, or the like acquired by the scanner unit 32.

In addition, a user who instructed the private printing (security printout with an authentication of the client (personal print)) instructs print output (printout) and then moves to the vicinity of the MFP 1 for authentication between the user (client) and the MFP 1 and for obtaining the print output. That is, according to the personal print, it is possible to avoid print output being collected by a third person by mistake due to the physical distance between the user and the MFP by the request for authentication between the MFP 1 and the user by the user who instructed the print output. On the other hand, user authentication is not usually omitted.

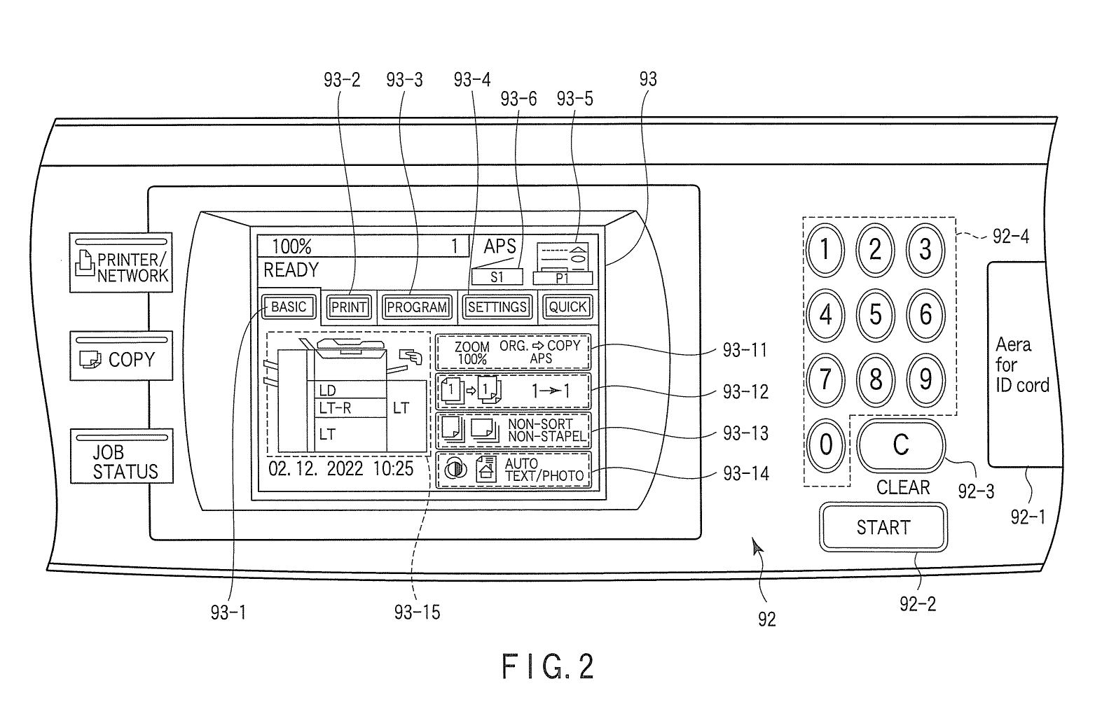

FIG. 2 shows a display example of the display 93 when the authentication between the MFP 1 and the user who instructed the aforementioned private printing is established and the private printing is permitted.

That is, it is possible to specify a user who instructed printing by the completion (establishment) of authentication in the MFP 1. Accordingly, the display of the display 93 in the MFP 1 shows a state in which a mode selection button display is displayed such as “BASIC” (basic mode) display 93-1 in which ordinary copying can be performed, “PRINT” (print mode) display 93-2 in which it is possible to set output form at the time of print mode such as image synthesis at the time of copying, image synthesis for scanned data or facsimile data, partial deletion, and the like, “PROGRAM” (program addition or deletion mode) display 93-3 which is activated for adding or deleting a program or at the time of updating, “SETTING” (setting mode) display 93-4 in which it is possible to change operation conditions (setting) for a user or an administrator, or the like. If, the “BASIC” (basic mode) accepts a simple copy job for which the number of sheets output is limited with a certain upper limit even in a non-authenticated state and for a non-authenticated person.

The indicators shown in FIG. 2 are displayed on the basis of, for example, font data and GUI (Graphical User Interface) data (including display rules) stored by the memory unit 33. The data and the display rules (the GUI data) for the indicators may be firmware of the MPU 91. The data and the display rules for the indicators can be updated through, for example, the extended interface unit 73.

The display example shown in FIG. 2 is an example in which a display screen based on default setting (“BASIC” (basic mode) display 93-1 in which ordinary copying can be performed) is displayed, the display including magnification input display 93-11 for accepting magnification setting during copying, output mode setting display 93-12 for accepting the setting of double-sided copy or an “N in 1” mode in which N (N is any of 1, 2, 4, or 8) pages are decreased in size and output on one page, discharge method designation display 93-13 for accepting the selection of a post-processing method for the output sheet such as stapling or the like, concentration setting display 93-14 for accepting the setting of tones at the time of copying and of reproducibility characteristics when photographs are included, sheet supply source selection display 93-15 for accepting the selection of the size of the sheet used for print output, which can be changed by a user, and the like.

In addition, FIG. 2 shows an example in which a start button 92-2 which instructs the start of print output based on the conditions set in each display 93-nn (n is any number from “0” to “9”), a clear button 92-3 with which it is possible to input the control command for changing the set condition again to the previous one, a numeric button 92-4 with which it is possible to input a command corresponding to a number from “0” to “9” in order to input a numeric value such as the number of sheets output, magnification, and the like are placed at a predetermined positions in the user interface 92 holding the display 93. In addition, a card reader 92-1 is placed at a predetermined position of the user interface 92 shown in FIG. 2, which is for reading an ID card for user authentication, for example, specifying a user, and making the functions permitted to the user available.

The display example shown in FIG. 2 further includes authorized user job display 93-5 and 93-6, each of which shows attribution of a job as an icon or an identifier (thumbnail) obtained by decreasing an image of a user's face or the like in size when there is a job relating to the authorized user (instructed by the authorized user). In addition, although FIG. 2 shows an example in which there are two kinds of authorized user job display, it is also applicable to display the user name and the number of jobs if the number of jobs to be displayed exceeds a predetermined number. Alternatively, it is also applicable to perform the display while the corresponding number of job display is partially overlapped with each other in order to display that there are plural jobs. In addition, the display example shown in FIG. 2 is an example which shows the “PRINT” display 93-5 in which one of the jobs is print output (from the PC) and the “SCAN” display 93-6 which is different from the print output and shows that the data read by the scanner unit 32 is being held in this drawing. If two or more print outputs are scheduled, it is possible to roughly identify the print targets by displaying the thumbnail of the first (top) page of each print target in an icon form.

That is, information of available functions permitted to the authorized user and icons showing the presence of data for private printing (personal print) instructed by the user, data scanned (by the scanner), received facsimile data, and the like are displayed in the display 93 of the MFP 1 for which user authentication was completed, based on the user information obtained by the card reader 92-1. In addition, if the (authorized) user touches the icon, the function of the job specified by the icon is activated, and the input screen is displayed in the display 93 in which it is possible to input the control information such as changes in the number of sheets output, size and kinds of the paper (sheet), the number of pages (of original data) output in one sheet, and the like into the same job, based on the control of the MPU 91. Moreover, it is also possible to perform the aforementioned operation using the icon 93-5 by selecting the “PRINT” display ([print] tab) 93-2 to display the “PRINT” ([print] mode activation) screen and selecting private printing in the screen in the display example shown in FIG. 2 though this is a general operation.

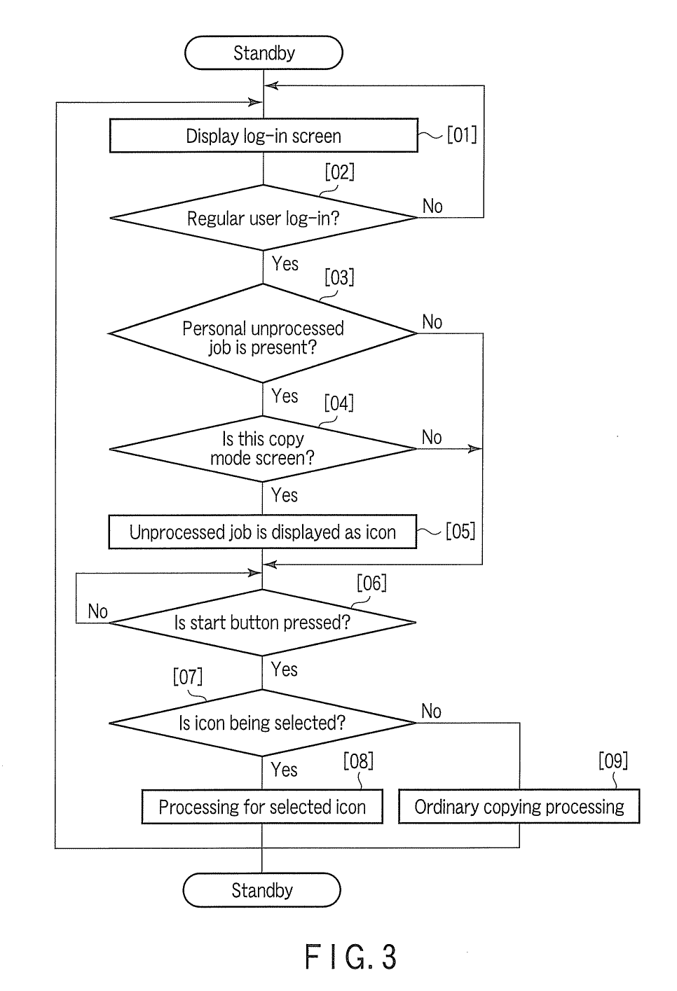

FIG. 3 shows an operation example when a user (client) inputs instruction (selection) in the display (user interface) shown in FIG. 2.

In the standby state, a “log-in screen” for user authentication is displayed in the display (touch panel) 93 of the user interface 92 of the MFP 1 [01]. While the log-in screen is displayed, user information is read from the ID card held by the user or a non-contact authentication card through the card reader 92-1, or the user directly inputs a password or the like [02—YES] to check the presence of [before processing job for person] approved (specified) for the authorized user [03].

If the screen display in the display 93 is a “screen for a copy operation (“BASIC” (basic mode) display in which ordinary copying can be performed) when the presence of a “before processing job for person” is checked [03—YES], the checked “before processing job for person” is displayed as an icon in the same display [05].

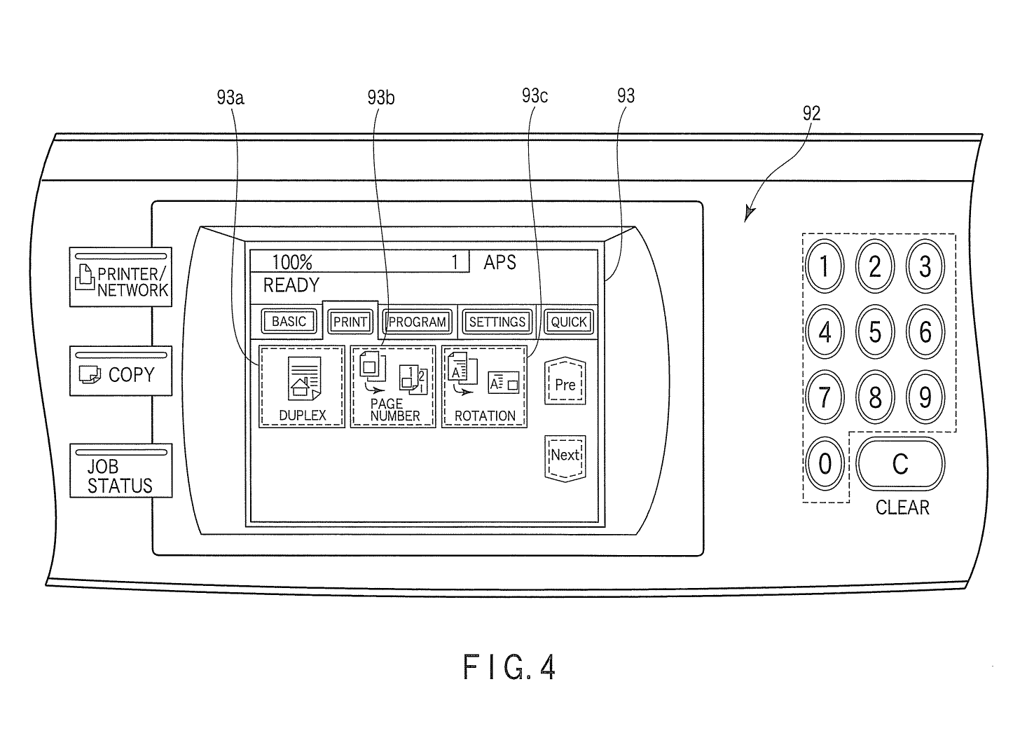

Hereinafter, if turning on the starting button (start button) [06—YES], and when selection is instructed (input) from the icon displaying the “before processing job for person” [07—YES], the job associated with the selected icon is activated. For example, if the job instructed by the (authorized) user is print output, and when the icon touched by the (authorized) user is the icon 93-5 (see FIG. 2) indicating the print output (from the PC), the “PRINT” (print mode) display 93-2 is displayed in which the print mode shown in FIG. 4, for example, can be set. The “PRINT” (print mode) display 93-2 includes “DUPLEX” (double-sided mode) display 93a which accepts the setting of double-sided print in the display being currently displayed by the display 93 when the setting is changed to the double-sided print, for example, page number display mode setting display 93b which accepts the setting of a “PAGE NUMBER” mode for simultaneously printing page numbers or not displaying the page numbers set (at the time of output from the PC), rotation mode display 93c which accepts the “ROTATION” (rotation mode) display 93c for rotating the direction of an image output on the sheet by 90°, and the like. Accordingly, the (authorized) user can instruct the changes at the time of printing by instructing (inputting) selection using the icons in the display being currently displayed without the procedure (steps) for displaying the “PRINT” (print mode) display from the screen display (configured in a stepwise manner) through plural operations from the display screen of the default setting (“BASIC” (basic mode) display 93-1 in which ordinary copying can be performed) [08].

In addition, when selection is not instructed (input) through the icon displaying the “before processing job for person”, or the display after the user authentication is “not the copy mode (for copy operation), or the “before processing job for person” is not present until the starting button (start button) is turned on, the display for the ordinary copying processing, that is, the “screen for an copy operation (“BASIC” (basic mode) display in which ordinary copying can be performed) is displayed by turning on the starting button (start button) (the screen in which the “screen for a copy operation (“BASIC” (basic mode) display in which ordinary copying can be performed)” displayed at the time of activation is maintained in practice) [09].

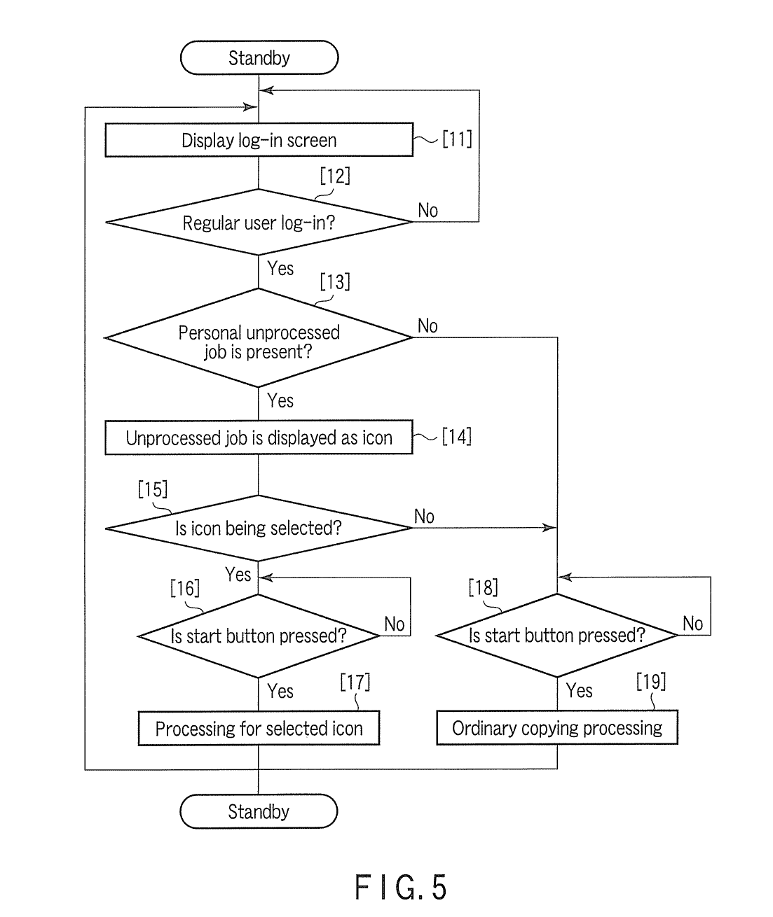

FIG. 5 shows a display example of the user interface (display) when the user who instructed private printing moves to the vicinity of the MFP and an example of printer operation activation for the private printing in the MFP shown in FIG. 1.

In the standby state, a “log-in screen” for user authentication is displayed in the display (touch panel) 93 of the user interface 92 of the MFP 1 [11].

While the log-in screen is displayed, user information is read from the ID card held by the user or a non-contact authentication card through the card reader 92-1, or the user directly inputs a password or the like [12—YES] to check the presence of [before processing job for person] approved (specified) for the authorized user [13].

When the presence of “before processing job for person” is checked [13—YES], at least the checked “before processing job for person” is displayed as an icon in the same display of the display 93 [14].

Hereinafter, when the authorized user selects the operation (activation of a processing mode) through an arbitrary icon displayed as a “before processing job for person” [15—YES], and the start (starting) button is turned on [16—YES], the job associated with the selected icon is activated, and the processing thereof is executed [17].

On the other hand, when the authorized user does not select (there is no selected input) the arbitrary icon displayed as a “before processing job for person” [15—NO], and the start (starting) button is turned on [18—YES], the display is shifted to the “BASIC (basic mode) display in which ordinary copying can be performed, and the state is changed to the standby state in which a copy operation (input) is available (“BASIC” (basic mode) display in which ordinary copying can be performed) displayed at the time of activation is maintained in practice) [19].

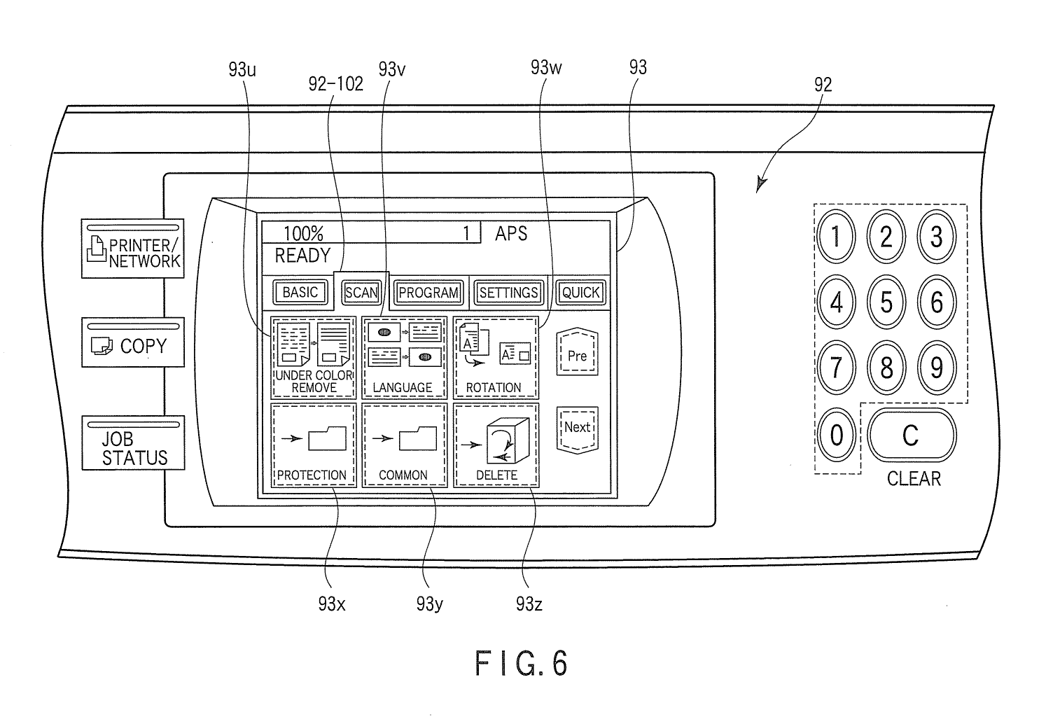

In addition, if the icon selected by the user is the one for scanning (see 93-6 in FIG. 2), for example, the “SCAN” (reading and processing mode) display 93-102 in which the setting relating to the processing of scanned data shown in FIG. 6 is displayed, for example. The “SCAN” (reading and processing mode) display 93-102 includes, for example, “UNDER COLOR REMOVE (base color removal) setting display 93u in which it is possible to input the setting for removing the color component of the base (sheet material) of the reading target, “LANGUAGE” setting display 93v in which it is possible to input the language at the time of reading (switch dictionaries to be used for character identification), rotation mode display 93w which accepts “ROTATION” (rotation mode) for rotating the direction of character strings by 90°, protection mode display 93x which accepts “PROTECTION” (protection mode) in which the storage destination of the read data is set to the one's own PC which cannot be accessed from the outside or to an unshared region, common mode display 93y which accepts “COMMON” (common mode) in which the storage destination of the read data is set to the shared region which can be freely viewed from the outside, mode display 93z which accepts “DELETE” (deletion mode) for the deletion of the read data, and the like.

That is, after scanning with the “SCAN” (see 93-6 in FIG. 2), the authorized user can set the storage destination of the data read by the scanner unit 32, realize efficiency in character recognition (character identification) in the later stage, set the processing for reducing false recognition of the read data, and the like.

In addition, a thumbnail image may be displayed for each page of the read data. If a specific page was not satisfactorily read, it is possible to immediately rescan the page by displaying the thumbnail image (of the respective read pages).

As described above, the complicated operations until the “PRINT” (print mode) display screen is displayed from the screen display configured in the stepwise manner becomes unnecessary by applying this embodiment.

In addition, it is possible to efficiently perform the operations of the MFP without deteriorating the operability and the visibility of the ordinary operation screen.

Further, it is also possible to easily notify the user who instructed a private job of the presence of the job for the user and of the type (attribute) of the job.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a storage section which holds a job instructed by a user and data to be used for the job;
a display section which displays that the job is present based on an association between the job held in the storage section and the user who instructed the job; and
a control section which permits the display section to display that the job associated with the user who instructed the job is present based on the association with the user who instructed the job held in the storage section.

2. The apparatus of claim 1, further comprising:
an authentication section authenticating the user who instructed the job held in the storage section.

3. The apparatus of claim 2, wherein the control section permits the display section to display that the job associated with the user who instructed the job is present if the authentication section authenticates the user who instructed the job held in the storage section.

4. The apparatus of claim 3, wherein the control section causes the display section to display that the job associated with the user who instructed the job is present and attributes of the job.

5. The apparatus of claim 3, wherein the control section causes the display section to display that the job associated with the user who instructed the job is present and attributes of the job using an identifiable display form.

6. The apparatus of claim 2, wherein the control section causes the display section to display that the job associated with the user who instructed the job is present and input display capable of inputting instructions corresponding to attributes of the job if the authentication section authenticates the user who instructed the job held in the storage section.

7. The apparatus of claim 6, wherein the control section causes the display section to display the attributes of the job associated with the user who instructed the job using an identifiable display form.

8. A method of instructing start of private printing comprising:
holding a job instructed by a user and data to be used for the job;
permitting a display region to display that the job associated with the user who instructed the job is present based on association between the job held in the holding and the user who instructed the job.

9. The apparatus of claim 8, further comprising:
authenticating the user who instructed the job held in the holding.

10. The apparatus of claim 9, wherein the display region is caused to display that the job associated with the user who instructed the job is present if the user who instructed the job held in the holding is authenticated.

11. The method of claim 10, wherein the display region is caused to display that the job associated with the user who instructed the job is present and attributes of the job.

12. The system of claim 11, wherein the display region is caused to display attributes of the job associated with the user who instructed the job using an identifiable display form.

13. The system of claim 9, wherein the display region is caused to display that the job associated with the user who instructed the job is present and input display capable of inputting instructions corresponding to attributes of the job if the user who instructed the job held in the holding is authenticated.

14. The method of claim 13, wherein the display region is caused to display the attributes of the job associated with the user who instructed the job using an identifiable display form.

15. A network system comprising:
an image forming apparatus including,
a display section which displays that the job is present based on an association between the job held in the storage section and the user who instructed the job; and
a control section which permits the display section to display that the job associated with the user who instructed the job is present based on the association with the user who instructed the job held in the storage section,
a network controller including,
a storage section which holds a job instructed by a user and data to be used for the job; and
an authentication section which authenticates the user who instructed the job held in the storage section.

16. The system of claim 15, wherein the control section causes the display section to display that the job associated with the user who instructed the job is present and attributes of the job.

17. The system of claim 16, wherein the control section causes the display section to display that the job associated with the user who instructed the job is present and attributes of the job using an identifiable display form.

18. The system of claim 15, wherein the control section causes the display section to display that the job associated with the user who instructed the job is present and input display capable of inputting instructions corresponding to attributes of the job if the authentication section authenticates the user who instructed the job held in the storage section.

19. The system of claim 18, wherein the control section causes the display section to display the attributes of the job associated with the user who instructed the job using an identifiable display form.

20. The system of claim 15, wherein the user includes a client PC connected to the network controller.
